(19) United States
(12) Patent Application Publication
(10) Pub. No.: US 2026/0014831 A1
(43) Pub. Date: Jan. 15, 2026

(54) CENTRAL AIR SOURCE SYSTEM FOR PASSENGER VEHICLES

(71) Applicant: Mastery Investment LLC, Kowloon KLN (HK)

(72) Inventors: Jianjun Tan, Kowloon KLN (HK); Daisy Lina Kwok, Kowloon KLN (HK)

(21) Appl. No.: 19/269,537

(22) Filed: Jul. 15, 2025

Related U.S. Application Data
(60) Provisional application No. 63/671,611, filed on Jul. 15, 2024.

(51) Int. Cl. B60H 1/00

(52) U.S. Cl. CPC B60H 1/00457

(57) ABSTRACT

A system is disclosed that includes a central air source system of a passenger car, which relates to the field of a vehicle air source system. The disclosed system includes an air supply unit, a high pressure tank, and a plurality of air springs. The air supply unit can communicate with and supply air to a high pressure tank and a plurality of air springs respectively, and the air supply unit is connected to an air unit and a low pressure tank. The air unit comprises a high pressure air group and a low pressure air group, and the high pressure tank is connected to a high pressure air group. The low pressure tank is connected to the low pressure air group, and the high and low pressure air group is provided with a fast connecting head.

### PRIORITY CLAIM

This application claims the benefit of and priority to U.S. Provisional Patent App. No. 63/671,611, titled “CENTRAL AIR SOURCE SYSTEM FOR PASSENGER VEHICLES”, filed Jul. 15, 2024, the contents of which are hereby incorporated by reference in their entirety.

### TECHNICAL FIELD

The disclosure relates to the technical field of a vehicle air source system, in particular to a central air source system for a passenger car.

### BACKGROUND

With the improvement of people's demand for ride comfort and convenience, the application scenarios of onboard pneumatic equipment are gradually increasing, such as some cars will be equipped with pneumatic massage seats or airbags that adjust the side support force according to the driving situation and other built-in pneumatic equipment. If each of these components is equipped with air compressors, the overall cost and weight increases for the car. If the same air compressor is used to supply air to a variety of air equipment at the same time, because the air pressure of these pneumatic equipment is different, the frequent adjustment of the air compressor will reduce the service life, and the stability of the air operation is poor.

At the same time, air mattresses and other external pneumatic equipment at this stage are mostly filled with a separate air pump, which increases the burden of car travel.

Therefore, the present disclosure is intended to provide a central air source system that reduces the cost and can be applied to a variety of pneumatic equipment at the same time, so as to improve the service life of the air compressor and the stability of the air supply.

### SUMMARY

To this end, the present disclosure provides a central air source system for a passenger car to solve the above defects in the prior art.

In a first aspect, which may be combined with any other aspect herein unless otherwise noted, a central air source system of a passenger vehicle comprises an air supply unit, a first air tank, and an air module, the air supply unit is configured to pneumatically communicate with and supply air to the first air tank and the air module respectively, and the air supply unit or the first air tank is connected with a quick connecting head for inflation of an external pneumatic device.

In a second aspect, which may be combined with any other aspect herein unless otherwise noted, the air supply unit includes an air compressor for compressed air, the motor used by the air compressor is a brushless motor, and the motor has a stepless frequency conversion control function.

In a third aspect, which may be combined with any other aspect herein unless otherwise noted, the air supply unit is configured to adopt an open air path or a closed air path.

In a fourth aspect, which may be combined with any other aspect herein unless otherwise noted, the air supply unit and the air tank are connected to an air unit, wherein the air unit comprises a high pressure air group and a low pressure air group.

In a fifth aspect, which may be combined with any other aspect herein unless otherwise noted, an air path connected with the air supply unit is provided with a fifth solenoid valve and a second solenoid valve, and the fifth solenoid valve is arranged near a side of the air tank, and an air path between the fifth solenoid valve and the second solenoid valve is pneumatically connected with the air unit.

In a sixth aspect, which may be combined with any other aspect herein unless otherwise noted, the air supply unit includes an air compressor for compressed air, the motor used by the air compressor is a brushless motor, and the motor has a stepless frequency conversion control function.

In a seventh aspect, which may be combined with any other aspect herein unless otherwise noted, the central air source system further comprises a pressure regulator on an intake pipe for connecting the quick connection head and the built-in pneumatic device.

In an eighth aspect, which may be combined with any other aspect herein unless otherwise noted, a central air source system of a passenger vehicle comprises an air supply unit, a first air tank, and an air module. The first air supply unit is configured to pneumatically communicate with and supply air to the first air tank and the air module respectively, and the air supply unit and the air tank are connected to an air unit, which air unit comprises a high pressure air group and a low pressure air group.

In a ninth aspect, which may be combined with any other aspect herein unless otherwise noted, both the high pressure air group and the low pressure air group include a built-in pneumatic device and a quick connecting head capable of pneumatically connecting with an external pneumatic device.

In a tenth aspect, which may be combined with any other aspect herein unless otherwise noted, an air path connected with the air supply unit is provided with a fifth solenoid valve and a second solenoid valve, and the fifth solenoid valve is arranged near a side of the first air tank, and an air path between the fifth solenoid valve and the second solenoid valve is pneumatically connected with the air unit.

In an eleventh aspect, which may be combined with any other aspect herein unless otherwise noted, the air supply unit includes an air compressor for compressed air, the motor used by the air compressor is a brushless motor, and the motor has a stepless frequency conversion control function.

In a twelfth aspect, which may be combined with any other aspect herein unless otherwise noted, the air supply unit is configured to adopt an open air path or a closed air path.

In a thirteenth aspect, which may be combined with any other aspect herein unless otherwise noted, a central air source system of a passenger car comprises an air supply unit, a first air tank, and an air module. The air supply unit is configured to pneumatically communicate with and supply air to the first air tank and the air module respectively, and the air supply unit is connected with an air unit and a second air tank, a permanent air pressure in the second air tank is lower than a permanent air pressure in the first air tank, the air unit comprises a high pressure air group and a low pressure air group, the first air tank is pneumatically connected to the high pressure air group, and the second air tank is pneumatically connected to the low pressure air group.

In a fourteenth aspect, which may be combined with any other aspect herein unless otherwise noted, both the high pressure air group and the low pressure air group include built-in pneumatic device and the external pneumatic device that can be pneumatically connected to the quick connection head.

In a fifteenth aspect, which may be combined with any other aspect herein unless otherwise noted, the central air source system further comprises a pressure regulator on an intake pipe for connecting the quick connection head and the built-in pneumatic device.

In a sixteenth aspect, which may be combined with any other aspect herein unless otherwise noted, the built-in pneumatic equipment comprises one or more of a seat wing support system, a seat massage system, the air motor, an autonomous driving camera/radar cleaning system, and the vehicle-mounted oxygen generator, and the external pneumatic equipment comprises one or more of an inflatable basketball, an inflatable tire, an inflatable mattress, and a pneumatic tool.

In a seventeenth aspect, which may be combined with any other aspect herein unless otherwise noted, an air path connected with the air supply unit is provided with a fifth solenoid valve and a second solenoid valve, and the fifth solenoid valve is arranged near a side of the first air tank, and an air path between the fifth solenoid valve and the second solenoid valve is pneumatically connected with the air unit.

In an eighteenth aspect, which may be combined with any other aspect herein unless otherwise noted, a third solenoid valve is arranged on an air path connected between the air supply unit and the intake end of the second air tank, and a tenth solenoid valve is arranged on an air path connected between the outlet end of the second air tank and the low-pressure air group.

In a nineteenth aspect, which may be combined with any other aspect herein unless otherwise noted, the air supply unit includes an air compressor for compressed air, the motor used by the air compressor is a brushless motor, and the motor has a stepless frequency conversion control function.

In a twentieth aspect, which may be combined with any other aspect herein unless otherwise noted, the air supply unit is configured to adopt an open air path or a closed air path.

The disclosed apparatus, systems, and/or methods have the following advantages:
(1) The central air source system of the invention is provided with a fast connecting head, which in one sense turns the car into a mobile air pump, which can inflate various external air devices anytime and anywhere, greatly facilitating the travel of personnel, and reducing the use of auxiliary air supply equipment, realizing lightweight while greatly reducing the cost;
(2) The disclosed apparatus, systems, and/or methods can supply air to various internal and external air equipment with different pressure application ranges only after pressure regulation by a high-pressure tank, and has a large application range;
(3) The disclosed apparatus, systems, and/or methods not only use a high pressure tank to supply air to the air unit, but also provide a low pressure tank to supply air to meet the air demand of different pneumatic equipment and realize gradient air supply: the high-pressure tank can inflate high-pressure air components directly or after pressure regulation, and the low-pressure tank can supply air to the low-pressure air group directly or after pressure regulation. Because the pressure regulation range is reduced and the number of intermediary components used for air supply is increased, the use frequency of the air compressor when a variety of air equipment is used at the same time can be reduced, and the service life of the air compressor and the stability of the air supply operation process can be improved.

Additional features and advantages of the disclosed system, method, and apparatus are described in, and are apparent from, the following Detailed Description and the Figures.

### BRIEF DESCRIPTION OF THE FIGURES

The accompanying drawings, which are incorporated in and constitute a part of this specification, show certain aspects of the subject matter disclosed herein and, together with the description, help explain some of the principles associated with the disclosed implementations.

FIG. 1 is a schematic diagram of a central air source system in which an air supply unit adopts an open air path.

FIG. 2 is a schematic diagram of the central air source system in which the air supply unit adopts a closed air path.

FIG. 3 is a schematic diagram of the central air source system in which a second air supply unit adopts an open air path.

FIG. 4 is a schematic diagram of the central air source system in which the second air supply unit adopts a closed air path.

FIG. 5 is a schematic diagram of a central air source system illustrating example the air unit, according to an example embodiment.

FIGS. 6A-6D are a flowchart depicting certain configurations of use of the central air source system.

FIG. 7 is an isometric view of an embodiment of the quick connection head of the central air source system.

### DETAILED DESCRIPTION

The following non-limiting designations are used in the figures,
1—Built-in pneumatic device;
2—Air spring;
3—Pressure sensor;
4—the first air tank;
5—the second air tank;
6—External pneumatic device;
7—quick connection head;
8—Pressure regulating valve;
9—the fifth solenoid valve;
10—the second solenoid valve;
11—the third solenoid valve;
12—the tenth solenoid valve;
13—the sixth solenoid valve;
14—the seventh solenoid valve;
15—the eighth solenoid valve;
16—the ninth solenoid valve;
100—air supply unit;
101—Air compressor;
102—air dryer;
103—Pneumatic discharge valve;
104—the first solenoid valve;
105—third check valve;
106—Main air path;
107—First exhaust air path;
108—Second exhaust air path;
109—Air supply circuit;
110—the fourth solenoid valve;
111—Exhaust air route 3;
112—Second air flow channel;
113—Third air flow channel;
114—Fourth air channel;
115—Fifth air flow channel;
116—Sixth airflow channel;
117—Seventh air flow channel;
118—Eighth air flow channel;
119—Ninth air flow channel;
200—air unit;
300—low pressure air group;
400—High pressure air group.

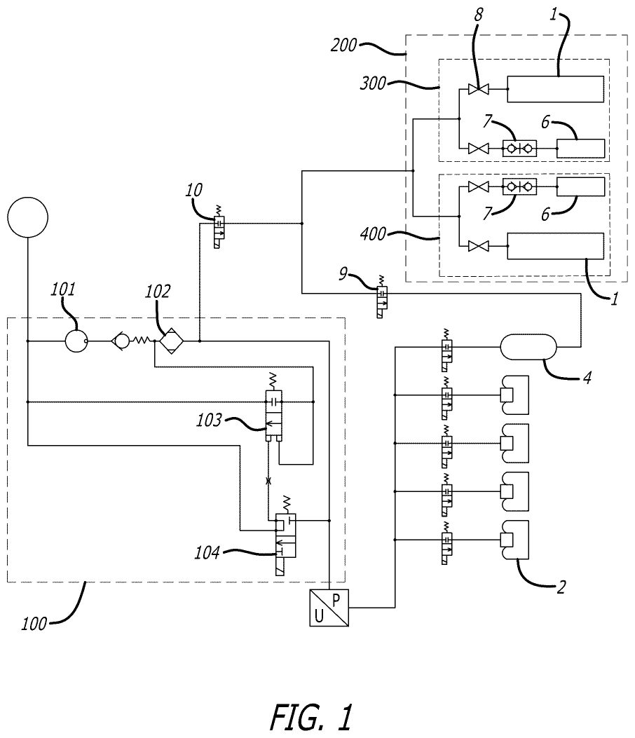

As shown in FIG. 1 to FIG. 4, the invention provides a central air source system for a passenger vehicle, comprising an air supply unit 100, a first air tank 4, and an air module. The air supply unit 100 can communicate with and supply air to the first air tank 4 and the air module respectively. The air module used may be an air spring 2. The air supply unit 100 comprises an air compressor 101 for compressed air, the motor used by the air compressor 101 is a brushless motor, and the motor has a stepless frequency conversion control function, so that the process of air compression is more efficient, energy-saving, stable, and reliable. The air supply unit 100 can adopt an open air path or a closed air path.

In order to reduce the vehicle inflation auxiliary equipment, reduce the weight of the car and improve the air utilization efficiency of the central air source system, the air supply unit 100 or a first air tank 4 is connected with a quick connecting head 7 for charging an external pneumatic device 6, through which the quick connecting head 7 can improve the air supply range of the air supply unit 100.

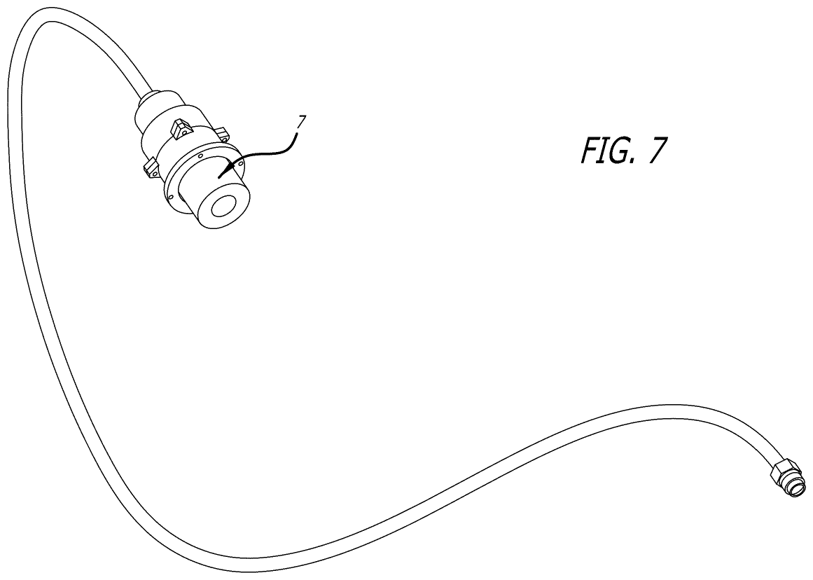

FIG. 7 illustrates an example of the quick connecting head 7 of the central air source system. The quick connecting head 7 is provided at one end of a pneumatic line. The quick connecting head 7 includes a cylindrical portion configured to fit into a corresponding port of a pneumatic device. In some embodiments, the quick connecting head includes a plurality of protrusions configured to provide further surface area and grip for a user connecting the quick connecting head 7 to a pneumatic device.

### Embodiment 1

A central air source system for a passenger vehicle comprises an air supply unit 100, a first air tank 4, and an air module. The air supply unit 100 can communicate with and supply air to the first air tank 4 and the air module respectively. The air supply unit 100 and the first air tank 4 (which in some embodiments is a high pressure tank) are connected with the air unit 200, and the permanent air pressure in the first air tank 4 (in embodiments where the first air tank 4 is a high pressure tank) is preferably 12-18 bar.

The air unit 200 comprises a high pressure air group 400 and a low pressure air group 300. That is, the air supply unit 100 and the first air tank 4 (high pressure tank) can both supply air to the high pressure air group 400 and the low pressure air group 300. In specific example embodiments:

The high pressure air group 400 and the low pressure air group 300 each include a built-in pneumatic device 1 and an external pneumatic device 6 that can be pneumatically connected to the quick connection head 7. The fast connection head 7 enables rapid connection between the central air supply system and the external pneumatic equipment 6.

The built-in pneumatic device 1 may be one or several of the seat wing support system, seat massage system, air motor, the autonomous driving camera/radar cleaning system, and the vehicle-mounted oxygen generator. The built-in pneumatic equipment 1 is not limited to the above, but can also be any functional equipment that can be installed in the interior of the car and requires the use of air as a power.

The external pneumatic equipment 6 may be in some embodiments an inflatable basketball, an inflatable tire, an inflatable mattress, an inflatable tent, a vehicle lift or jack, a seat adjustment mechanism (such as for forward or backward seat movement, backrest tilting, height adjustments, etc.), a window lifting/lowering mechanism, a wiper blade mechanism, a sunroof opening/closing system, an air conditioning air door control mechanism, a door lock mechanism, and/or a pneumatic tool. The pneumatic tools may comprise, for example, a pneumatic wrench.

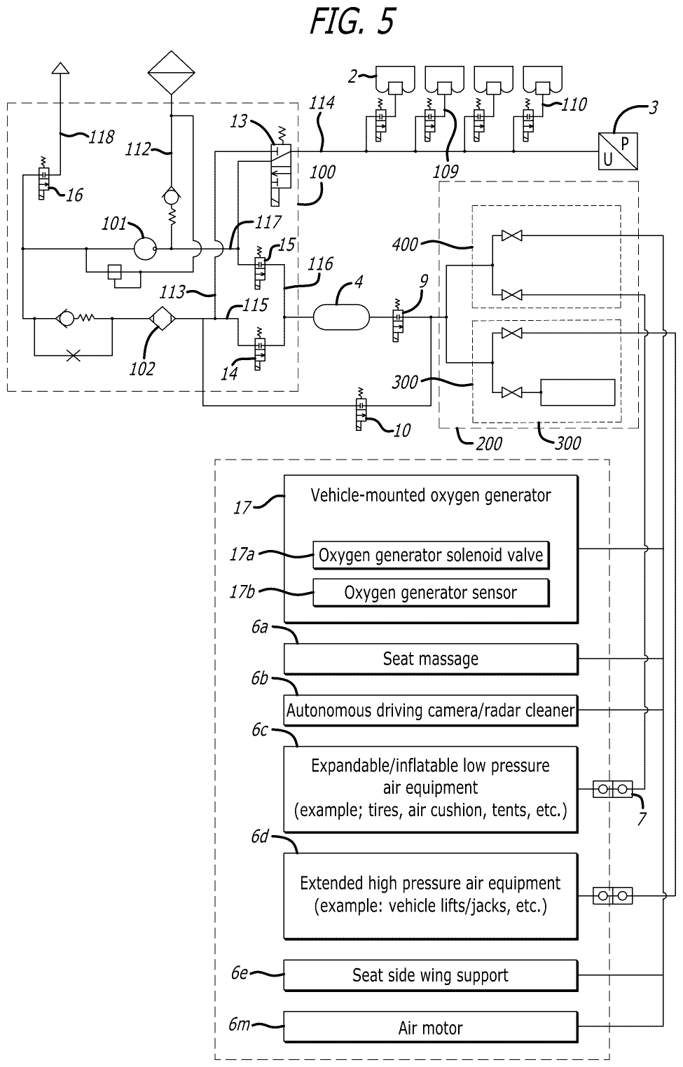

FIG. 5 illustrates an example configuration of the air unit 200 which may be pneumatically connected to the air supply system. The external pneumatic equipment 6 in FIG. 5 includes an expandable/inflatable low pressure air device 6c (examples of which include tires, air cushions, tents, etc.), and an extended high pressure air device 6d (examples of which include a vehicle lift or jack, etc.). Also included as the built-in pneumatic device 1 is a seat massage 6a, the seat side wing support 6e, the air motor 6m, an autonomous driving camera/radar cleaner 6b, and a vehicle-mounted oxygen generator 17 which includes an oxygen generator solenoid valve 17a and an oxygen generator sensor 17b.

In addition, the air path connecting the air outlet end of the first air tank 4 and the air supply unit 100 is provided with a fifth solenoid valve 9 and a second solenoid valve 10, the fifth solenoid valve 9 is arranged near the side of the first air tank 4, and the air path between the fifth solenoid valve 9 and the second solenoid valve 10 is connected with the air unit 200.

### Embodiment 2

A central air source system for a passenger vehicle comprises an air supply unit 100, a first air tank 4, and an air module. The air supply unit 100 can communicate with and supply air to the first air tank 4 and the air module respectively. The air supply unit 100 is connected with an air unit 200 and a second air tank 5 (which in some embodiments is a low pressure tank), the permanent air pressure in the second air tank 5 (low pressure tank) is lower than the permanent air pressure in the first air tank 4 (high pressure tank). The air unit 200 comprises a high pressure air group 400 and a low pressure air group 300. The first air tank 4 (high pressure tank) is connected with a high pressure air group 400, and the second air tank 5 (low pressure tank) is connected with a low pressure air group 300. That is, the air supply unit 100 can supply air to the high pressure air group 400 and the low pressure air group 300, the first air tank 4 (high pressure tank) can supply air to the high pressure air group 400, and the second air tank 5 (low pressure tank) can supply air to the low pressure air group 300. The permanent air pressure in the second air tank 5 (low pressure tank) is preferably 4-6 bar. The advantage of this setting mode is that it can meet the air demand of different pneumatic equipment and realize gradient air supply. Because the pressure regulation range is reduced, the stability of the air supply operation process is improved. At the same time, the above systems and methods can reduce the frequency of use of air compressor 101 and improve its service life.

In some embodiments, a pressure regulator 8 is arranged on an intake pipe connecting the quick connection head 7 and the built-in pneumatic device 1. In the process of specific operation, the pressure regulator 8 is a pneumatic pressure regulator or an electric pressure regulator.

When the air pressure required by the built-in pneumatic device 1 and the external pneumatic device 6 is close to the standing air pressure in the storage tank 5 (low pressure tank), the pressure regulator 8 on the corresponding intake air path can be eliminated, so that the number of pressure regulators 8 can be reduced and cost can be saved.

In the above embodiment, a third solenoid valve 11 is arranged on the air path connecting the air supply unit 100 with the intake end of the second air tank 5, and a tenth solenoid valve 12 is arranged on the air path connecting the air outlet end of the second air tank 5 with the low pressure air group 300.

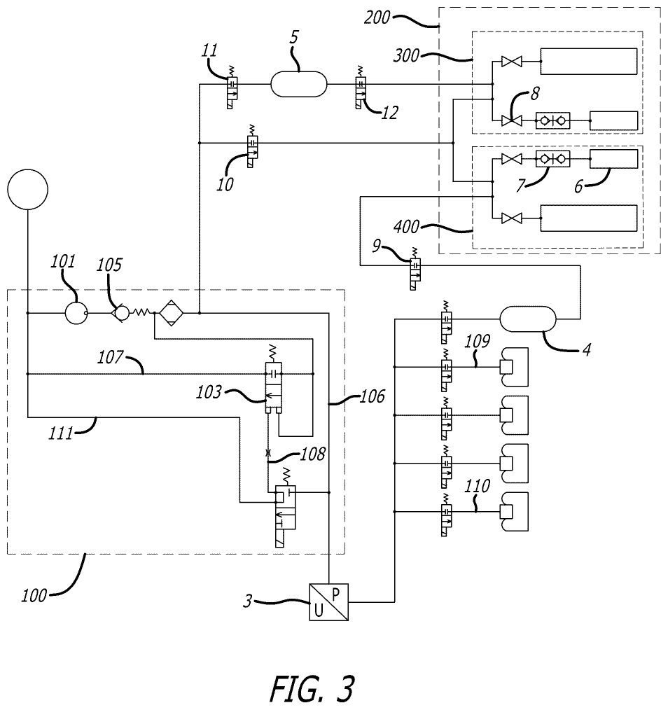

When the air supply unit 100 is an open air path: as shown in FIG. 1 corresponding to Embodiment 1 and FIG. 3 corresponding to Embodiment 2, the air supply unit 100 comprises a main air path 106, an air compressor 101, a third check valve 105, an air dryer 102 and a pressure sensor 3 successively connected to the main air path 106. The main air path 106 between the third check valve 105 and the air dryer 102 is provided with a first node, the first node is connected with the main air path 106 located upstream of the air compressor 101 and is provided with a first exhaust air path 107, the first exhaust air path 107 is provided with a pneumatic discharge valve 103. The pneumatic discharge valve 103 is used to control the on-off of the exhaust air path 107, the main air path 106 between the air dryer 102 and the pressure sensor 3 is provided with a second node, and the second node and the pneumatic discharge valve 103 are connected through the second exhaust air path 108. The second exhaust air path 108 is provided with a first solenoid valve 104 (which may be a two-position three-way solenoid valve), and the first solenoid valve 104 is also capable of pneumatic communication with the atmosphere through the third exhaust air path 111. The first solenoid valve 104 can switch between the second exhaust air path 108 and the main air path 106, or the third exhaust air path 111 and the main air path 106.

In some embodiments, up to four air springs 2 are provided, the first air tank 4 and the air spring(s) 2 are connected to the main air path 106 through the supply air path 109, and a fourth solenoid valve 110 is arranged on the supply air path 109. The fourth solenoid valve 110 is used to control the on-off of the supply air path 109.

The working process of the open air supply unit is as follows:

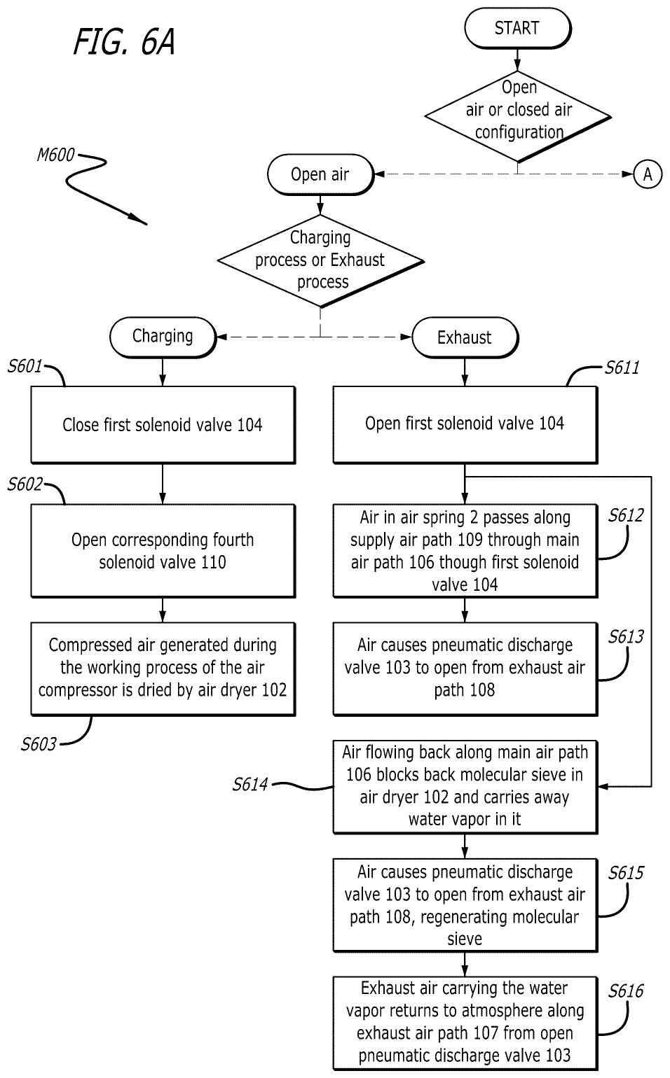

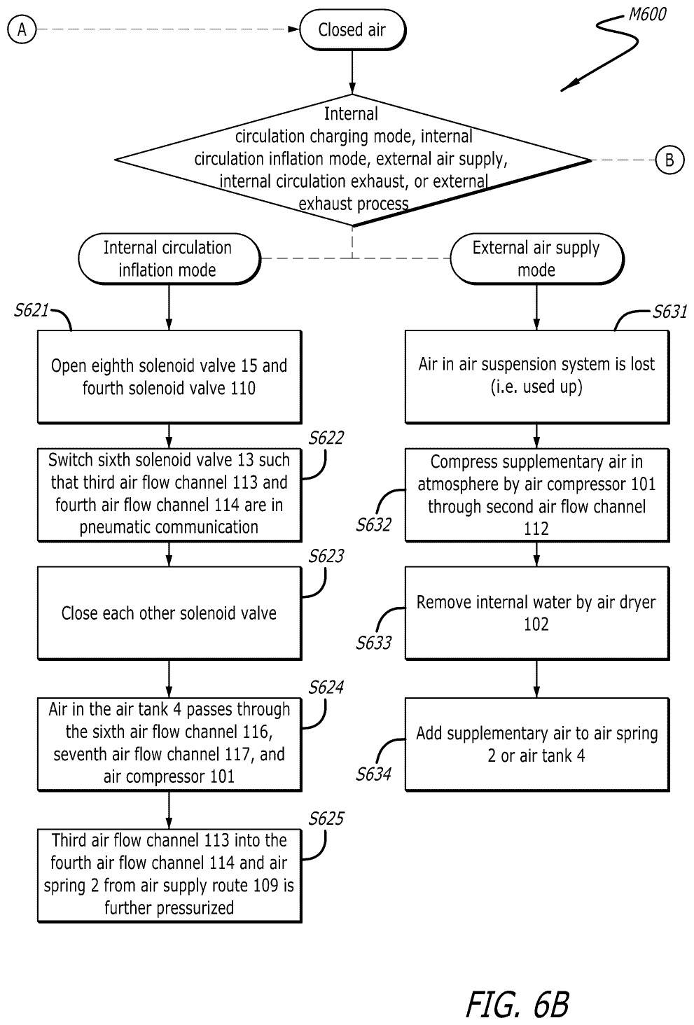

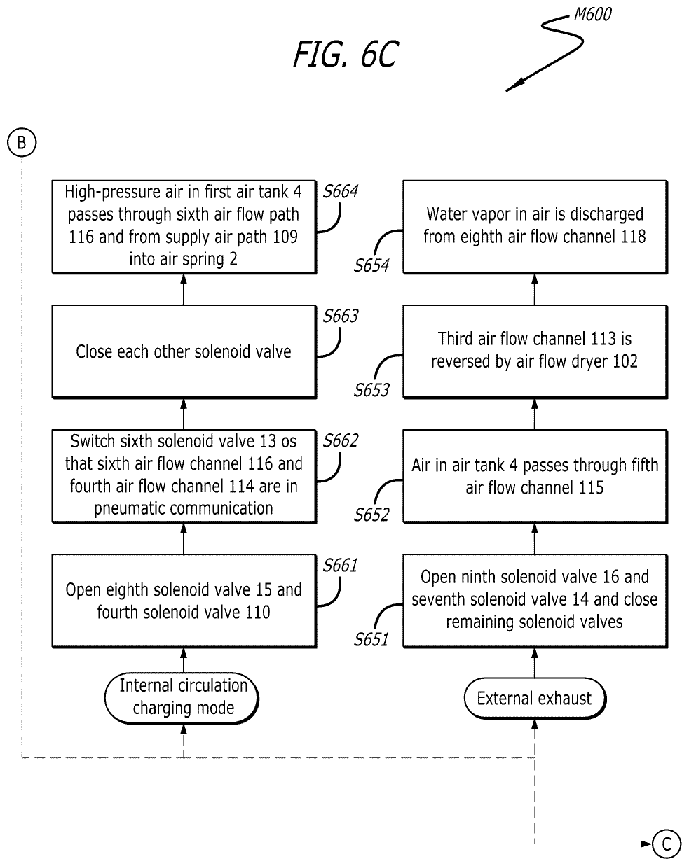

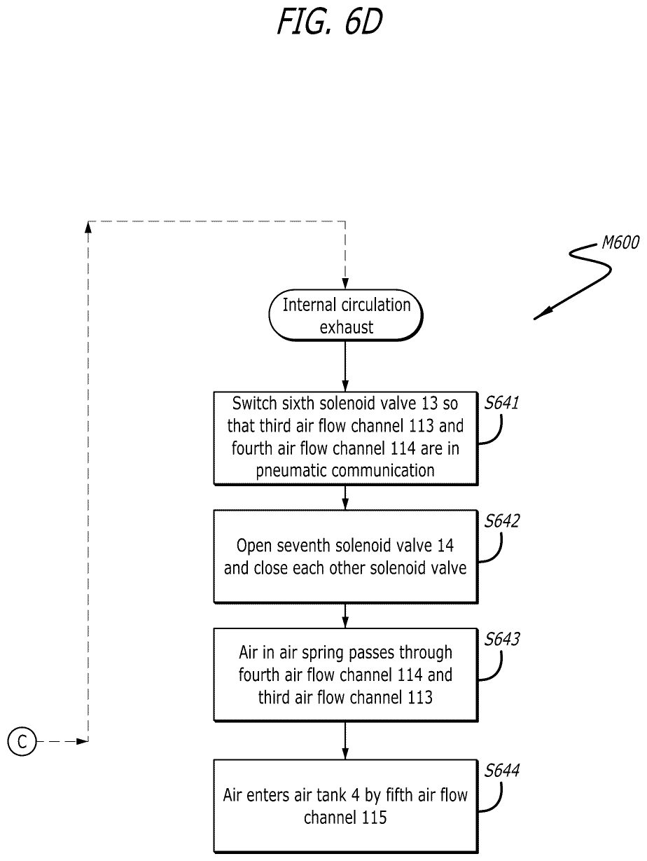

During the inflation process, as illustrated by the method M600 in FIGS. 6A-6D: close the first solenoid valve 104 at step S601, open the corresponding fourth solenoid valve 110 at step S602, and the compressed air generated during the working process of the air compressor 101 is dried by the air dryer 102 at step S603 and enters the air spring 2 or the first air tank 4 to complete the charging of the air spring 2 and the first air tank 4.

In the exhaust process, as further illustrated by the method M600 in FIGS. 6A-6D: open the first solenoid valve 104 at step S611, the air in the air spring 2 passes along the supply air path 109 through the main air path 106 through the first solenoid valve 104 at step S612 and causes the pneumatic discharge valve 103 to open from the exhaust air path 108 at step S613. At the same time, the air flowing back along the main air path 106 blows back the molecular sieve (or filter) in the air dryer 102 and carries away the water vapor in it at step S614, so that the molecular sieve “regenerates” at step S615, and the exhaust air carrying the water vapor returns to the atmosphere along the exhaust air path 107 from the open pneumatic discharge valve 103 at step S616.

When the first solenoid valve 104 closes the pipe line, the high-pressure air remaining in the pneumatic discharge valve 103 can be discharged from the second exhaust air path 108 and discharged into the atmosphere through the first solenoid valve 104 from the third exhaust air path 111.

When the air supply unit 100 is in a closed air path configuration:

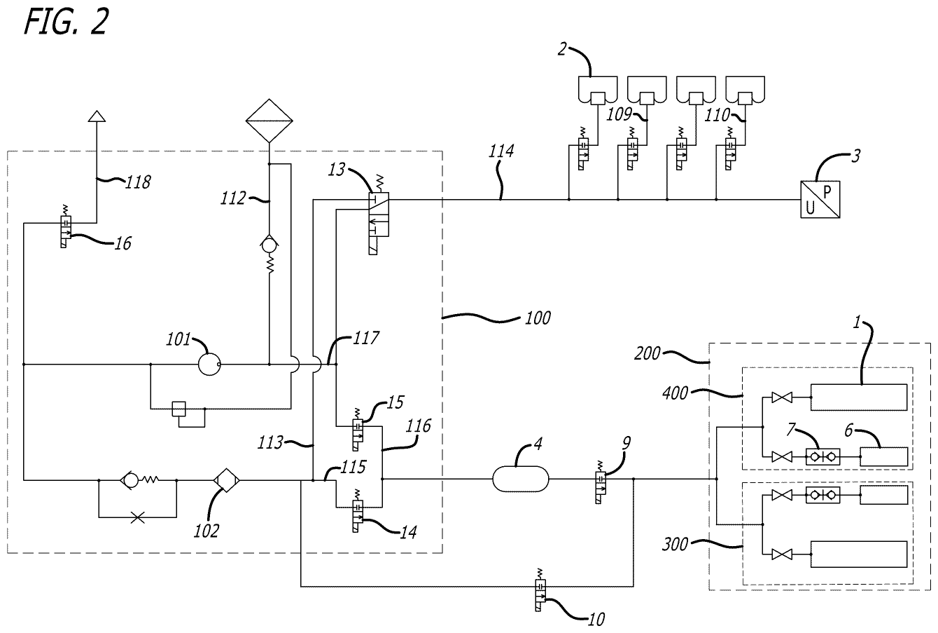

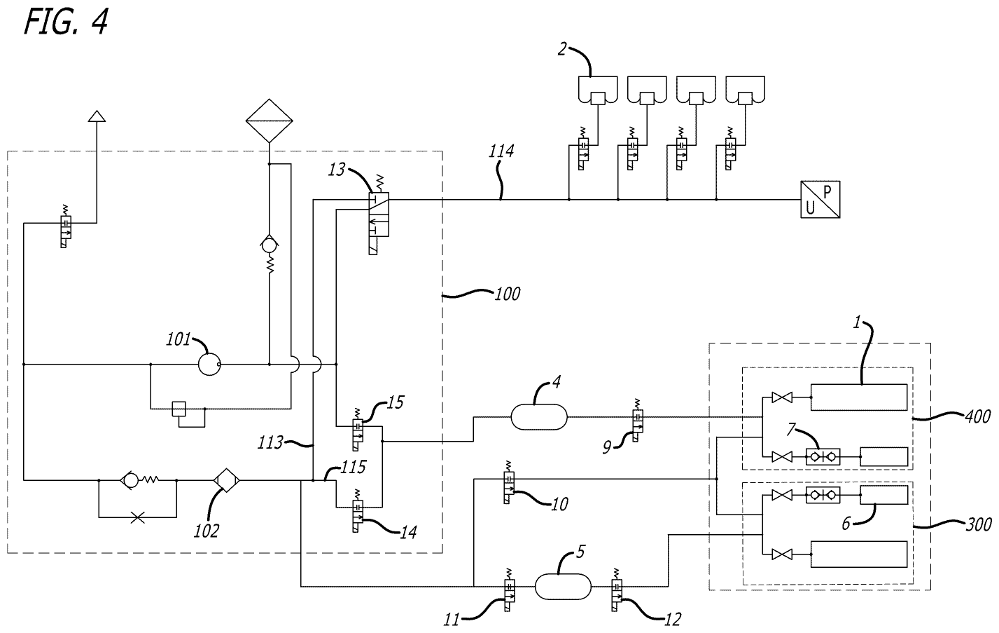

As shown in FIG. 2 corresponding to Embodiment 1 and FIG. 4 corresponding to Embodiment 2, the air supply unit 100 comprises a second air flow channel 112, a third air flow channel 113 and a fourth air flow channel 114. The second air flow channel 112 is connected to the air intake end of the air compressor 101 through a check valve. The air outlet end of the air compressor 101 is connected with one end of the third air flow channel 113, the other end of the third air flow channel 113 is connected with a sixth solenoid valve 13, and the sixth solenoid valve 13 is connected with an air spring 2 through the fourth air flow channel 114. The third air flow channel 113 is also provided with an air dryer 102 through a check valve, and the third air flow channel 113 between the air dryer 102 and the sixth solenoid valve 13 is connected with the fifth air flow channel 115 in pneumatic communication with the first air tank 4 (high pressure tank) through a node. The fifth air flow channel 115 is provided with a seventh solenoid valve 14, and the fifth air flow channel 115 between the seventh solenoid valve 14 and the first air tank 4 is connected with the sixth solenoid valve 13 through the sixth air flow channel 116, and the sixth solenoid valve 13 is a two-position three-way solenoid valve. The sixth solenoid valve 13 is used to switch the fourth air flow channel 114 and the third air flow channel 113 or where the sixth air flow channel 116 is connected, the sixth air flow channel 116 is provided with an eighth solenoid valve 15. The sixth solenoid valve 13 and the eighth solenoid valve 15 are provided with a seventh air flow channel 117 communicated with the second air flow channel 112, the third air flow channel 113 between the air compressor 101 and the air dryer 102 is provided with a fulcrum connected with the eighth air flow channel 118. The eighth air flow channel 118 is provided with a ninth solenoid valve 16.

The working process of the closed air supply unit is as follows, as illustrated by method M600 in FIGS. 6A-6D:

Internal circulation charging mode: Open the eighth solenoid valve 15 and fourth solenoid valve 110 at step S661, and switch the sixth solenoid valve 13 of the sixth air flow channel 116 and the fourth air flow channel 114 to be in pneumatic communication with each other at step S662, and close each other solenoid valve at step S663. The high-pressure air in the first air tank 4 passes through the sixth air flow path 116 and from the supply air path 109 into the air spring 2 at step S664.

Internal circulation inflation mode: Open the eighth solenoid valve 15 and the fourth solenoid valve 110 at step S621, and switch the sixth solenoid valve 13 such that the third air flow channel 113 and the fourth air flow channel 114 are in pneumatic communication with each other at step S622, and close each other solenoid valve at step S623. The air in the first air tank 4 passes through the sixth air flow channel 116, the seventh air flow channel 117 and the air compressor 101 at step S624 to further pressurize the third air flow channel 113 into the fourth air flow channel 114 and the air spring 2 from the air supply route 109 at step S625.

External air supply: When the air in the air suspension system is lost at step S631, the supplementary air in the atmosphere will be compressed by the air compressor 101 through the second air flow channel 112 at step S632, and the internal water will be removed at step S633 by the air dryer 102, and then added to the air spring 2 or the first air tank 4 at step S634.

Internal circulation exhaust: Switch the sixth solenoid valve 13 such that the third air flow channel 113 and the fourth air flow channel 114 are in pneumatic communication with each other at step S641, open the seventh solenoid valve 14, and close each other solenoid valve at step S642. Under the action of the air compressor 101, the air in the air spring 2 passes through the fourth air flow channel 114 and the third air flow channel 113 at step S643 and enters the first air tank 4 by the fifth air flow channel 115 at step S644.

External exhaust: When a certain amount of water vapor accumulates in the air suspension system, open the ninth solenoid valve 16 and the seventh solenoid valve 14, and close the remaining solenoid valves at step S651. The air in the first air tank 4 passes through the fifth air flow channel 115 at step S652, the third air flow channel 113 is reversed by the air dryer 102 at step S653, and the water vapor in the air is discharged from the eighth air flow channel 118 at step S654.

When the central air source system is running, the internal and external pneumatic equipment of the vehicle is divided into two groups of a high pressure air group 400 and a low pressure air group 300 according to the air pressure when the pneumatic equipment is used. During driving or stopping, an embodiment is produced by the air supply unit 100 or the air in the first air tank 4 (high pressure tank) where air is supplied to a pneumatic device of a high pressure air group 400 and a low pressure air group 300 after pressure regulation. In another embodiment, a second air tank 5 (low pressure tank) is added, the air in the first air tank 4 (high pressure tank) supplies air to a high pressure air group 400 after pressure regulation, and the air in a second air tank 5 (low pressure tank) supplies air to a low pressure air group 300 after pressure regulation, and the gradient air supply can satisfy the simultaneous use of multiple pneumatic equipment.

In some embodiments, the central air source system of the disclosure is provided with a fast connecting head 7, which turns the car into a mobile air pump, which can inflate various external pneumatic equipment 6 anytime and anywhere, greatly facilitating the travel of personnel, and reducing the use of auxiliary air supply equipment, realizing a lightweight configuration and greatly reducing the cost.

The scheme of Embodiment 1 of the disclosure is configured to supply air to various internal and external air equipment with different pressure application ranges after pressure regulation by a high-pressure tank. It should be appreciated that Embodiment 1 has a large application range.

In other embodiments, Embodiment 2 of the disclosure not only uses a high-pressure tank to supply air to the air unit, but also provides a low-pressure tank to supply air to meet the air demand of different pneumatic equipment and realize gradient air supply. Due to the reduction of pressure regulation range and the increase of the number of “intermediaries” used for air supply, the use frequency of the air compressor can be reduced when multiple air equipment is used at the same time. This in turn may improve the service life of the air compressor and the stability of the air supply process.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. As one example, reference is made throughout to “solenoid valves”. It should be understood that a solenoid valve may be replaced with any electromechanical valve or other valve capable of carrying out the claimed systems, methods, or apparatus capabilities.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of these terms also does not exclude the possibility of other unrecited features or elements and is merely meant to be illustrative, unless otherwise implicitly or explicitly contradicted by the context in which it used.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above.

The invention is claimed as follows:

1. A central air source system of a passenger vehicle comprising:
an air supply unit;
a first air tank; and
an air module,
wherein the air supply unit is configured to pneumatically communicate with and supply air to the first air tank and the air module respectively, and
wherein the air supply unit or the first air tank is connected with a quick connecting head for inflation of an external pneumatic device.

2. The central air source system of a passenger vehicle according to claim 1, wherein the air supply unit includes an air compressor for compressed air, the motor used by the air compressor is a brushless motor, and the motor has a stepless frequency conversion control function.

3. The central air source system for a passenger vehicle according to claim 1, wherein the air supply unit is configured to adopt an open air path or a closed air path.

4. The central air source system for a passenger vehicle according to claim 1, wherein the air supply unit and the air tank are connected to an air unit, wherein the air unit comprises a high pressure air group and a low pressure air group.

5. The central air source system for a passenger vehicle according to claim 4, wherein an air path connected with the air supply unit is provided with a fifth solenoid valve and a second solenoid valve, and the fifth solenoid valve is arranged near a side of the air tank, and an air path between the fifth solenoid valve and the second solenoid valve is pneumatically connected with the air unit.

6. The central air source system for a passenger vehicle according to claim 4, wherein the air supply unit includes an air compressor for compressed air, the motor used by the air compressor is a brushless motor, and the motor has a stepless frequency conversion control function.

7. The central air source system for a passenger vehicle according to claim 1, further comprising a pressure regulator on an intake pipe for connecting the quick connection head and the built-in pneumatic device.

8. A central air source system of a passenger vehicle comprising:
an air supply unit;
a first air tank; and
an air module,
wherein the air supply unit is configured to pneumatically communicate with and supply air to the first air tank and the air module respectively, and
wherein the air supply unit and the first air tank are connected to an air unit, wherein the air unit comprises a high pressure air group and a low pressure air group.

9. The central air source system for a passenger vehicle according to claim 8, wherein both the high pressure air group and the low pressure air group include a built-in pneumatic device and a quick connecting head capable of pneumatically connecting with an external pneumatic device.

10. The central air source system for a passenger vehicle according to claim 8, wherein an air path connected with the air supply unit is provided with a fifth solenoid valve and a second solenoid valve, and the fifth solenoid valve is arranged near a side of the first air tank, and an air path between the fifth solenoid valve and the second solenoid valve is pneumatically connected with the air unit.

11. The central air source system of a passenger vehicle according to claim 8, wherein the air supply unit includes an air compressor for compressed air, the motor used by the air compressor is a brushless motor, and the motor has a stepless frequency conversion control function.

12. The central air source system for a passenger vehicle according to claim 8, wherein the air supply unit is configured to adopt an open air path or a closed air path.

13. A central air source system of a passenger vehicle comprising:
an air supply unit;
a first air tank; and
an air module,
wherein the air supply unit is configured to pneumatically communicate with and supply air to the first air tank and the air module respectively, and
wherein the air supply unit is connected with an air unit and a second air tank, a permanent air pressure in the second air tank is lower than a permanent air pressure in the first air tank, the air unit comprises a high pressure air group and a low pressure air group, the first air tank is pneumatically connected to the high pressure air group, and the second air tank is pneumatically connected to the low pressure air group.

14. The central air source system for a passenger vehicle according to claim 13, wherein both the high pressure air group and the low pressure air group include built-in pneumatic device and the external pneumatic device that can be pneumatically connected to the quick connection head.

15. The central air source system for a passenger vehicle according to claim 14, further comprising a pressure regulator on an intake pipe for connecting the quick connection head and the built-in pneumatic device.

16. The central air source system for a passenger vehicle according to claim 14, wherein the built-in pneumatic equipment comprises one or more of a seat wing support system, a seat massage system, the air motor, an autonomous driving camera/radar cleaning system, and the vehicle-mounted oxygen generator, and
wherein the external pneumatic equipment comprises one or more of an inflatable basketball, an inflatable tire, an inflatable mattress, and a pneumatic tool.

17. The central air source system for a passenger vehicle according to claim 13, wherein an air path connected to the air supply unit is provided with a fifth solenoid valve and a second solenoid valve, the fifth solenoid valve being arranged near a side of the first air tank, and an air path between the fifth solenoid valve and the second solenoid valve being pneumatically connected to the air unit.

18. The central air source system for a passenger vehicle according to claim 13, wherein a third solenoid valve is arranged on an air path connected between the air supply unit and the intake end of the second air tank, and a tenth solenoid valve is arranged on an air path connected between the outlet end of the second air tank and the low-pressure air group.

19. The central air source system of a passenger vehicle according to claim 13, wherein the air supply unit includes an air compressor for compressed air, the motor used by the air compressor is a brushless motor, and the motor has a stepless frequency conversion control function.

20. The central air source system for a passenger vehicle according to claim 13, wherein the air supply unit is configured to adopt an open air path or a closed air path.
